(19) United States
(12) Patent Application Publication
(10) Pub. No.: US 2002/0198733 A1
(43) Pub. Date: Dec. 26, 2002

(54) Virtual outlet establishment mediation method, virtual outlet establishment mediation program, and virtual outlet establishment mediation server

(75) Inventors: Hirofumi Sawa, Kawasaki (JP); Takeshi Ito, Kawasaki (JP); Yumi Asano, Kawasaki (JP); Akira Tashiro, Kawasaki (JP); Hitoshi Monma, Kawasaki (JP); Hiroaki Nishimura, Kawasaki (JP); Hiroyuki Sato, Kawasaki (JP); Hiroshi Hatakama, Kawasaki (JP); Miwako Isa, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/106,489

(22) Filed: Mar. 27, 2002

(30) Foreign Application Priority Data
Jun. 26, 2001 (JP) 2001-193225

(51) Int. Cl. G06F 17/60

(52) U.S. Cl. 705/1

(57) ABSTRACT

A computer network system that executes a virtual outlet establishment mediation method is composed of a plurality of user terminals, a plurality of servicer terminals, and a single virtual outlet establishment mediation server that are capable of communicating via the Internet with one another. The virtual outlet establishment mediation server extracts one or more servicers whose desiring conditions (business group, region) match the attributes (business group, region) of a user. From the servicer or servicers extracted here, the virtual outlet establishment mediation server extracts servicers with attributes (product lineup, payment methods, delivery time, discount rate, point rate) that satisfy the conditions (product lineup, payment methods, delivery time, discount rate, point rate) desired by the user.

### BACKGROUND OF THE INVENTION

1. Field of the Invention

The present invention relates to a virtual outlet establishment mediation method and a virtual outlet establishment mediation server for mediating between a user who wishes to have a virtual outlet established on an Web Page that is transmitted via a network to terminals operated by members of the user and servicers that wish to establish such a virtual outlet. The present invention also relates to a virtual outlet establishment mediation program that enables a computer to function as this kind of virtual outlet establishment mediation server.

2. Description of the Prior Art

Upon receipt of a URL, a user computer connected to the Internet and executing a WWW browser program accesses a web server indicated by the URL, receives an HTML file stored at a site indicated by the URL, and displays a web page with content according to a hypertext in the file. Such a web system allows a user operating the user computer to browse information published on the Internet by worldwide web servers.

A web server (web site) providing a web page (portal screen) appropriate to be initially accessed by a user computer just after it activating the WWW browser is normally termed a portal site. A portal screen transmitted from such a portal site to the user computer is typically designed so that it contains an item linked to another site or an item for operating a search engine for searching another web page. In some cases, a portal site displays information for users provided by its administrator on the portal screen.

In recent years, a service provider under a contract with certain organizations (such as a government agency, a municipal organization, a company, a religious organization, a local group, etc.) have offered then a system that transmit a portal screen with contents for providing services to members of the organization via the Internet, using web systems. For examples, services that can be provided to members of the organization using such portal screens include in-house retailing of goods in an company, selling of course books, uniforms, stationary, etc. to pupils or teachers of a school, selling of goods, etc. that are required for group activities to members of a club, a religious organization, or a local community, and selling of goods to members of a group composed of customers of a business, with such services being actually provided by a business (hereafter “servicer”) with which the organization has entered into a contract. The provision of services by this kind of servicer is achieved using a servicer's site to which the portal screen is linked. In the following description, the setting of a link to the servicer's site on the portal screen is referred to as the “establishment of a virtual outlet.”

In many cases, to improve the welfare of members and/or to encourage more people to join them as members, most organizations have servicers, who wish to sell the kinds of goods mentioned above within an organization, sell such goods to members of the organization at less their standard retail prices. Further, certain types of organizations let servicers, that deal with products that are difficult to obtain at normal retailers, sell such products to the members of the organization.

Conventionally, in order to be given the chance by organizations to offer products to their members, servicers have had to enter into individual negotiation with person in charge at each of the organizations.

In order to improve the inconvenience discribed above, Japanese Patent Laid-Open Publication No. Hei. 10-269282 discloses a mediation system that selects one servicer at random out of a plurality of servicers that handle the same types of goods. This mediation system does not select one out of servicers at even probability, but selects one at probability which reflects a level of satisfaction with the servicer of persons that have had actual dealings with the servicer in the past.

In case the above mediation system is used to select one out of a plurality of servicers that want to establish a virtual outlet on a portal screen, if only a person in charge of a servicer registers various conditions (for example, the discount rate offered with regard to regular retail prices, delivery time, number of products, payment methods, etc.) for the provision of services by that servicer, it becomes possible for any organization to enter into a contract with this servicer for the establishment of a virtual outlet according to those conditions. As a result, a virtual outlet can be established easily without the servicer having to enter into individual negotiation with the person in charge at each of the organizations. On the other hand, a servicer is selected with a probability that reflects the level of satisfaction with them of persons that have had actual dealings with them in the past, so that it becomes possible for an organization to enter into a contract for the establishment of a virtual outlet with a servicer that has a high probability of being able to satisfy the members of the organization who is the “user” of this mediation system.

However, when the conventional mediation system is used to select one out of a plurality of servicers that wish to establish a virtual outlet on a portal screen, a servicer that is thought to be desirable according to subjective criteria of a user (such as, magnitude of special relationships with servicers relating to the activities of the organization themselves, e.g., that where a user and a servicer are related by belonging to same business group or by having had prior dealings) is not always selected. Therefore, there are cases where the organization has misgivings about entering into a contract with the selected servicer.

On the other hand, when the conventional meditation system is used, a servicer may be selected by a user that is undesirable to the servicer according to the criteria of the servicer (for example, a user whose members make few purchases, a user which belongs to a rival business group, or a user in a region located far from the servicer). Accordingly, there are also cases where servicers wish to restrict the possible candidates with which a contract can be signed.

Also, while a servicer may wish to change its proposing conditions for the provision of services in accordance with user attributes, such as the total number of members of a user, the amount of purchases made by the members and the average income of the members, it is not able to cope with such requests through the conventional mediation system.

### SUMMARY OF THE INVENTION

It is an object of the present invention to provide a virtual outlet establishment mediation method for mediating between a user that wishes to have a virtual outlet established on an web page that is transmitted via a network to terminals operated by members of a user and servicer that wishes to establish such a virtual outlet, a virtual outlet establishment mediation server, and a virtual outlet establishment mediation program that enables a computer to function as this kind of virtual outlet establishment mediation server.

According to the present invention, condition that is desired by a servicer with regard to the attributes of users is compared with an attribute of each user, condition that is desired by a user with regard to the attributes of servicers is compared with an attribute of each servicer, and combinations of a user and a servicer in which attribute of each of them satisfies other's condition are extracted. Then, a screen that shows the attributes of each servicer that has been combined with a requesting user and the conditions that are desired by these servicers is presented to the requesting user. Then, a servicer that has been selected by the requesting user to whom the screen has been presented is registered as a servicer who is to establish a virtual outlet on an web page transmitted to members of the requesting user.

As a result, only servicers with attributes that match the user's desires are displayed on the screen, so that it is easy for a user to select a servicer with even better conditions from the servicers displayed on the screen, thereby making it possible to have a virtual outlet of that servicer established on the web page exclusive to members of the user. The displayed servicers has been winnowed to those of which conditions are satisfied with the attributes of that user, so that there are no cases where a servicer that has been selected to establish a virtual outlet on an web page exclusive to members of this user does not wish to do business with this user.

It should be noted that the attribute of a servicer may include a record of the actual establishment of a virtual outlet by the servicer. In the same way, the attribute of a user may include a record of the actual purchase of products by members of this user that have been made via virtual outlets. The attributes of a user may also include the region in which the user operates. In the same way, the attributes of a servicer may also include the region in which the servicer operates. Attributes of a user may also include the business group to which the user belongs. In the same way, the attributes of a servicer may also include the business group to which the servicer belongs. The attributes of a user may include the total number of members in the user.

### BRIEF DESCRIPTION OF THE DRAWINGS

The invention will be described below in detail with reference to the accompanying drawings, in which:

FIG. 1 is a block diagram schematically showing one embodiment of a computer network system applied with the virtual outlet establishment mediation method of the present invention;

FIG. 2 is a front view of a typical computer;

FIG. 3 is a block diagram schematically showing a configuration of the internal circuit of a user terminal;

FIG. 4 is a block diagram schematically showing a configuration of the internal circuit of an establishment mediation server;

FIG. 5 is a diagram showing a data structure of a user's desiring condition database stored in the establishment mediation server;

FIG. 6 is a diagram showing a data structure of a first servicer's proposing condition database stored in the establishment mediation server;

FIG. 7 is a diagram showing a data structure of a second servicer's proposing condition database stored in the establishment mediation server;

FIG. 8 is a diagram showing a data structure of a matching result database stored in the establishment mediation server;

FIG. 9 is a diagram showing a data structure of a servicer adjustment table stored in the establishment mediation server;

FIG. 10 is a diagram showing a data structure of an established outlet database stored in the establishment mediation server;

FIG. 11 is a diagram showing a data structure of an establishment record database stored in the establishment mediation server;

FIG. 12 is a diagram showing a data structure of a purchase record database stored in the establishment mediation server;

FIG. 13 is a flowchart showing a matching process performed by the establishment mediation server;

FIG. 14 is a flowchart showing a servicer selection screen generating process performed by the establishment mediation server;

FIG. 15 is a flowchart showing an assigning process performed by the establishment mediation server;

FIG. 16 is a flowchart showing a selected servicer registering process subroutine performed by the establishment mediation server;

FIG. 17 shows a servicer selection screen that is displayed by a user terminal; and

FIG. 18 shows a servicer list screen that is displayed by a user terminal.

### DESCRIPTION OF THE PREFERRED EMBODIMENT

The following describes a preferred embodiment of the present invention, with reference to the accompanying drawings.

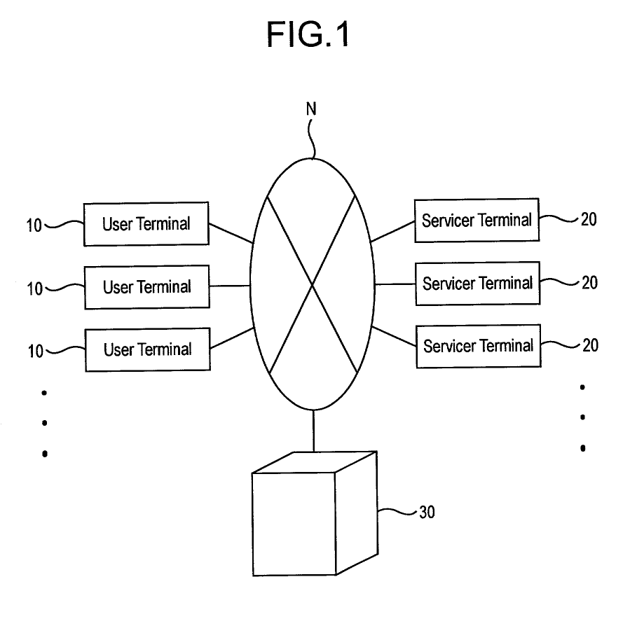

FIG. 1 is a block diagram schematically showing an overall configuration of a computer network system that is applied with the virtual outlet establishment mediation method of the present invention. As shown in FIG. 1, the computer network system of the embodiment includes a plurality of user terminals 10, a plurality of servicer terminals 20, and a single establishment mediation server 30 that are connected to each other via the Internet N.

The establishment mediation server 30 is a computer that is operated by a service provider who provides service of offereing a portal screen to members of an organization (who is a “user”) and mediates between the user and a servicer in accordance with the virtual outlet establishment mediation method. Each user terminal 10 is a computer that is operated by a person in charge of an organization as a “user” that enters into a contract with the service provider regarding the provision of the portal screen. It should be noted that, in the present embodiment, the organizations as users are companies, such as businesses. Each servicer terminal 20 is a computer that is operated by a servicer that wishes to establish its own virtual outlet on a portal screen intended for members of any one of the organizations.

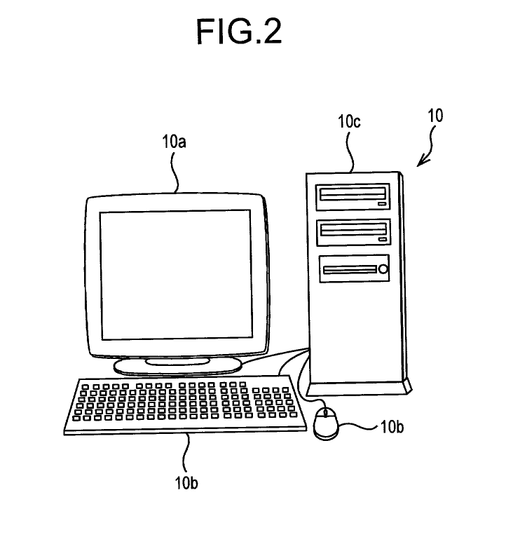

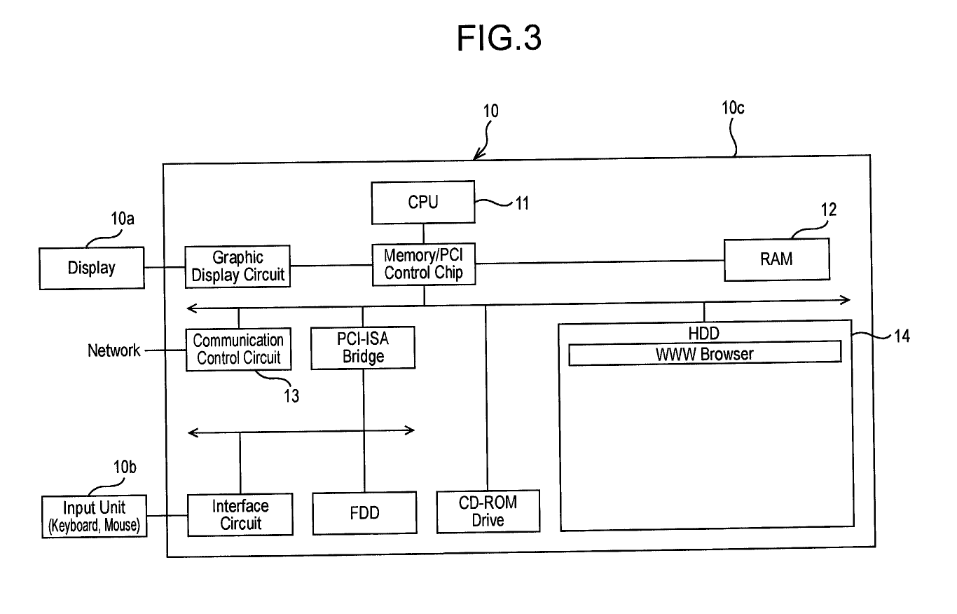

As shown by the representation given in FIG. 2, the user terminal 10 is a standard, network-communicatable computer that is set up of a display 1a for displaying a variety of display screens, an input unit 10b such as a keyboard and mouse, and a main body 10c to which the display 10a and the input unit 10b are connected. FIG. 3 is a block diagram schematically showing a configuration of the internal circuit of the main body 10c. As shown in FIG. 3, the internal circuit of the main unit 10c is composed of devices such as a CPU 11, a ram 12, a communication control circuit 13, and an HDD 14.

The CPU 11 is a central processing unit for integrally controlling the individual devices 12 through 14. The RAM 12 is a random access memory that is used to cache a variety of programs that have been read by the CPU 11 and also provides a work area for the CPU 11. The communication control circuit 13 includes a network adopter, a modem, a DSU or a NIC connectable to the Internet N via a communication line such as a phone line or a LAN and controls data transmission and reception to and from computers connected to the network N.

The HDD 14 is a storage unit from and in which various data and programs are read and written. The HDD 14 stores various data used in a process performed by the CPU 11, application programs executed by the CPU 11 to provide various functions, and OS (Operating System) programs for managing the execution of the application programs and the network. It should be noted that the application programs stored in the HDD 14 include an information viewing program called a WWW (World Wide Web) browser. When this WWW browser is being executed by the CPU 11 and a network address called a URL (Uniform Resource Locator) is inputted through the input unit 10b to the CPU 11, the WWW browser has the CPU 11 access a WWW server indicated by the URL and request a file that is stored at a site indicated by the URL. When an HTML (HyperText Markup Language) file is received in response to this request, the WWW browser has the CPU 11 read the hypertext data stored in the file and display a web page represented by this hypertext data on the display 10a. The request for and reception of the file is performed in accordance with TCP/IP (Transmission Control Protocol/Internet Protocol) and HTTP (Hyper-Text Transfer Protocol).

In the same way as a user terminal 10, a servicer terminal 20 is composed of a typical computer. Accordingly, no explanation is given for the construction of the servicer terminals 20.

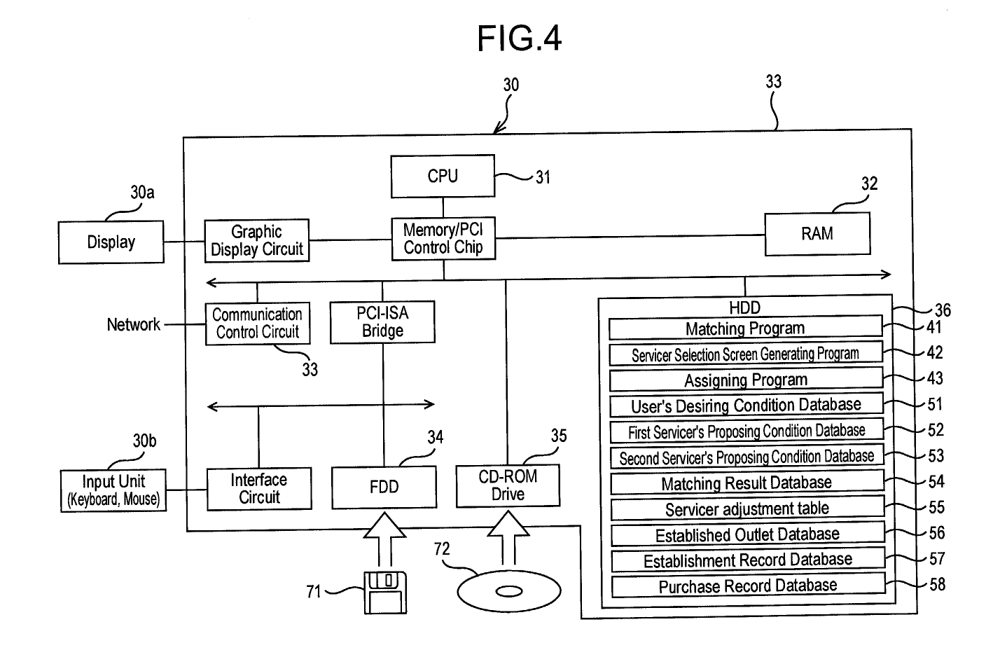

The establishment mediation server 30 is a computer that functions as what is called a “web server”, which transmits data files in response to information viewing requests from user terminals 10 or servicer terminals 20 that are connected to the Internet N. FIG. 4 is a block diagram schematically showing a configuration of the internal circuit of the establishment mediation server 30. As shown in FIG. 4, the establishment mediation server 30 is composed of devices such as a CPU 31, a RAM 32, a communication control circuit 33, an FDD 34, a CD-ROM drive 35, and an HDD 36. The CPU 31, the RAM 32, and the communication control circuit 33 have the same functions as the devices 11 through 13 shown in the block diagram in FIG. 3, so that no explanation is given for these devices.

When various programs, data, or upgrade versions thereof are to be installed, a flexible disk 71 or CD-ROM disk 72 which are computer readable media in which these programs and data are recorded are loaded in the FDD 34 or the CD-ROM drive 35 so that the programs and data are read out of the flexible disk 71 or the CD-ROM disk 72. The programs and data that are read in this way are installed onto the HDD 36.

The HDD 36 stores a variety of data, a variety of application programs, and an OS program. While not shown in the drawings, the HDD 36 stores a plurality of HTML files, a server program, and an authentication table. The HTML files store hypertext data, for example one having a portal screen displayed and one having a log-in screen displayed, which are intended for each employee belonging to particular user companies. The server program includes WWW server program and sends the HTML file for a portal screen intended for the employees belonging to a particular user only to the employees. The authentication table is registered with a log-in ID and password, etc., for authenticating the employee of each user company. It should be noted that URLs are assigned to the locations at which the HTML files are stored. Also, when receiving a request that indicates the URL of an HTML file for a log-in screen from any one of the terminals on the Internet N, the CPU 31 that is executing the server program described above responds by sending the HTML file for the log-in screen to the terminal. After this, when receiving a request including a combination of a log-in ID and password that is registered in the authentication table (not shown in the drawings) from the terminal, the CPU 31 sends, to the terminal, the HTML file for the portal screen corresponding to the company to which the person intended for this log-in ID belongs to as a response. It should be noted that this portal screen may include tool buttons that (that is, icons) for which URLs have been set as linked targets of hyperlinks. When this portal screen is displayed by one of the terminals and one of the tool buttons is clicked, the WWW browser 55 executed by this terminal transmits a request message indicating the URL that is set for this tool button. Note that a matching program 41 (corresponding to a matching unit), a servicer selection screen generating program 42 (corresponding to a screen presentation unit), and an assigning program 43 are also stored in the HDD 36.

The matching program 41 is a program that makes the CPU 31 extract servicers that wish to establish a virtual outlet in a product field for which a company as a user wishes to have a virtual outlet established on the portal screen intended for their employee, judge whether the establishment conditions proposed by the extracted servicers match the user's desiring conditions, and store servicers whose establishment conditions match the desired conditions of the user in a matching result database 54 (described later in this specification).

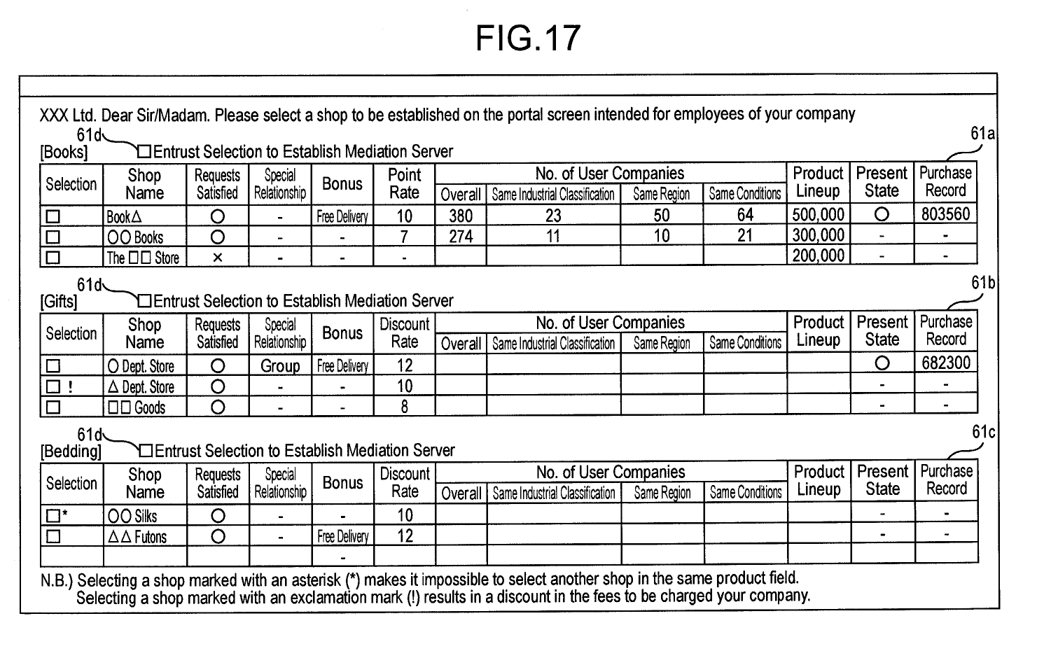

The servicer selection screen generating program 42 is a program that makes the CPU 31 generate a servicer selection screen 61 (see FIG. 17) for presenting users with information related to the servicers extracted by the execution of the matching program 41.

The assigning program 43 is a program that makes the CPU 31 select a servicer when the user company entrusts the system with the selection of the servicer, generate an established outlet database 56 (described later in this specification) for storing information relating to the servicer selected by the CPU 31 or by the user company, and generate an establishment record database 57 and a purchase record database 58 (both described later in this specification) for accumulating data on the deals made by servicers and the purchase records of users.

The HDD 36 also stores a user's desiring condition database 51, a first servicer's proposing first condition database 52, a second servicer's proposing condition database 53, a matching result database 54, a servicer adjustment table 55, an established outlet database 56, an establishment record database 57, a purchase record database 58 and a database program for updating, adding to and deleting the content of these databases.

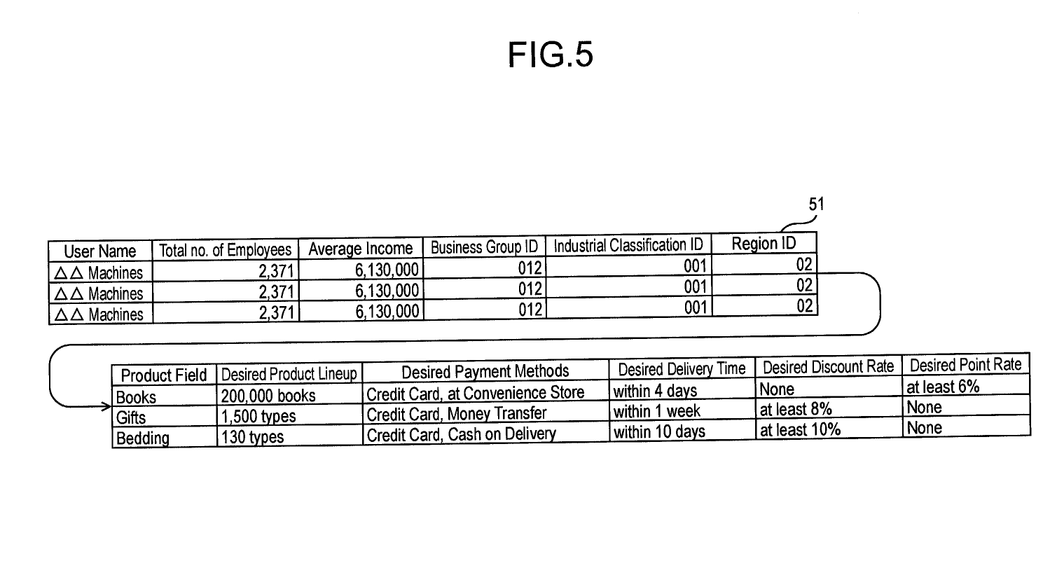

The user's desiring condition database 51 is a database for storing conditions that each of the user companies desires as to attributes of a servicer and attribute information of the user company themselves. FIG. 5 is a diagram showing the data structure of the user's desiring condition database 51. As shown in FIG. 5, the user's desiring condition database 51 has records respectively consisting of the following fields: “user name”; “total number of employees”; “average income”; “business group ID”; “industrial classification ID”; “region ID”; “product field”; “desired product lineup”; “desired payment methods”; “desired delivery time”; “desired discount rate”; and “desired point rate”. Such records are prepared for respective product fields for which a user company wishes a virtual outlet to be established on a portal screen dedicated to their employees. The “user name” field stores the name of the user company. The “total number of employees” and “average income” fields respectively stores the total number of employees belonging to the user company and their average income. The “business group ID”, “industrial classification ID”, and “region ID” fields respectively store identification information showing the business group to which the user company belongs, identification information showing the industrial classification into which the user company is classified, and identification information showing the location of the user company. The “product field” shows the category of products which the user company wishes to be sold by a servicer through a virtual outlet on the portal screen dedicated to the employee. The “desired payment methods” field shows a method of payment desired by the user company. The “desired delivery time” field shows delivery time for products desired by the user company. The “desired discount rate” field shows a rate at which the user company wishes the products to be discounted from the standard retail prices. Finally, the “desired point rate” field shows the rate at which the user company wishes points to be issued to the retail prices of products. It should be noted that these points are issued to each employee with a predetermined timing or whenever each employee buys specified products, and go at a virtual outlet in the same way as money. The point rate shows a rate of points issued with regard to the retail price of a product. As one example, when the point rate is 1%, 100 points are issued when a product costing $100 is purchased.

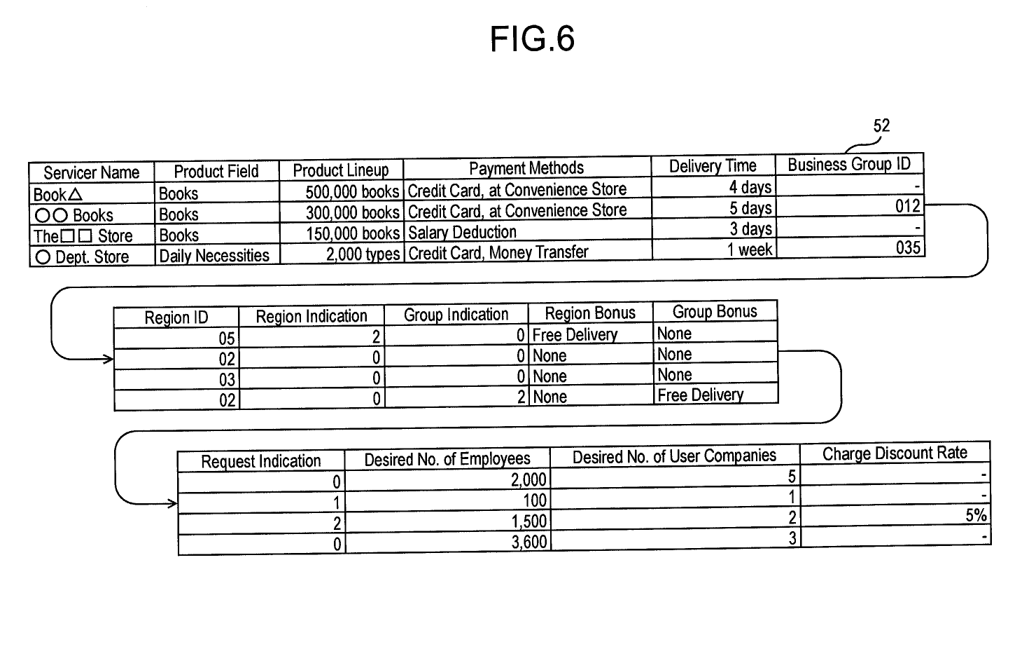

The first servicer's proposing condition database 52 is a database storing sales conditions (including conditions proposed as to the user attributes) under which servicers want to sell products through a virtual outlet and attribute information of the servicers. FIG. 6 is a diagram showing the data structure of the first servicer's proposing condition database 52. As shown in FIG. 6, the first servicer's proposing condition database 52 is composed of records respectively consisting of the fields of: “servicer name”; “product field”; “product lineup”; “payment methods”; “delivery time”; “business group ID”; “region ID”; “region indication”; “group indication”; “region bonus”; “group bonus”; “request indication”; “desired number of employees”; “desired number of user companies”; and “charge discount rate”. Such records are prepared for respective product fields in which each servicer wishes to sell products via a virtual outlet. The “servicer name” field shows the name of the servicer. The “product field” field shows the category of products that the servicer sells via virtual outlets. The “product lineup” field shows the total number of different products in this product field that are sold by this servicer. The “payment methods” field shows the payment methods that are accepted by this servicer. The “delivery time” field shows the shortest delivery time in which this servicer can provide a purchaser with a product. The “business group ID” and “region ID” fields respectively show identification information of a business group to which the servicer belongs and identification information of the location of the servicer. The “region indication” field stores identification information of a desired location of user companies which the servicer wishes to establish a virtual outlet on the portal screens intended for the employees of. The “group indication” field shows identification information of a business group to which user companies which the servicer wishes to establish a virtual outlet on their portal screen. The “region bonus” field shows identification information of a bonus that is to be given by the servicer to user companies located in the region indicated by the “region indication” field. The “group bonus” field shows identification information of a bonus that is to be given by the servicer to user companies that belong to the business group indicated by the “group indication” field. The “request indication” field shows a desire of the servicer regarding the scale of a virtual outlet to be established on the portal screen. The “request indication” field set at zero indicates that the servicer does not have any request regarding the scale of the virtual outlet. The “request indication” field set at one indicates that the servicer has a desire as to number of user companies which they establishes virtual outlets on portal screens intended for employees of. The “request indication” field set at two indicates that the servicer has a desire as to number of employees which they establish outlets on portal screens intended for. When the “request indication” field is set at one, the “desired number of user companies” field shows the total number of user companies for which the servicer wishes to establish outlets on portal screens intended for their employees. When the “request indication” field is set at two, the “desired number of employees” field shows the total number of employees belonging to user companies that is desired by the servicer to establishing virtual outlets on portal screens intended for them. When the “request indication” field is set at one or two, the “charge discount rate” shows a discount rate that is applied for the fee charged to the user selecting this servicer. It should be noted that the amount that is discounted from the fee to be charged to the user is borne by the servicer.

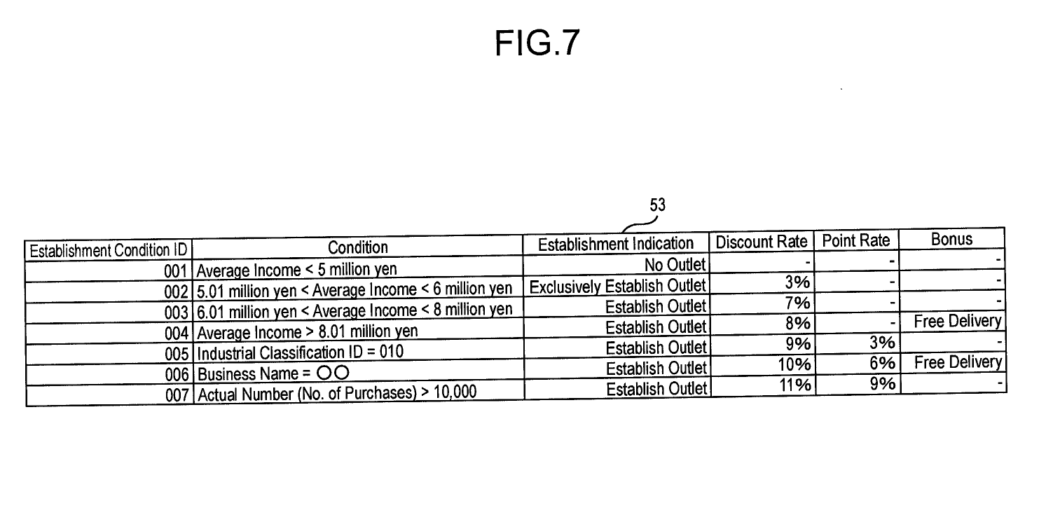

The second servicer's proposing condition database 53 is a database storing establishment conditions proposed by a servicer regarding the user companies which the servicer establishes a virtual outlets on the portal screen intended for the employees of. The second servider's proposing condition database 53 is prepared for each of the servicers. FIG. 7 is a diagram showing the data structure of the second servicer's proposing condition database 53. As shown in FIG. 7, the second servicer's proposing condition database 53 is composed of records respectively consisting of the fields of: “establishment condition ID”; “condition”; “establishment indication”; “discount rate”; “point rate”; and “bonus”. These records are prepared for respective conditions. The “establishment condition ID” field stores identification information for identifying respective conditions. The “condition” field shows the conditions proposed by the servicer and regarding the users companies which the servicer establishes a virtual outlet on a portal screen intended for employees of. In the servicer second condition database 53, the records are arranged in order of advantage for the servicer as to the condition in the “condition” field with starting from least advantageous one. The “establishment indication” field shows whether the servicer wishes to establish a virtual outlet on the portal screen intended for employees belonging to a user company that satisfies the condition in the “condition” field. The “discount rate” and “point rate” fields respectively show the discount rate and point rate that are applied for the employee of a user company that satisfies the condition in the “condition” field. The “bonus” field shows a bonus that is provided to the employee of a user company that satisfies the condition in the “condition” field.

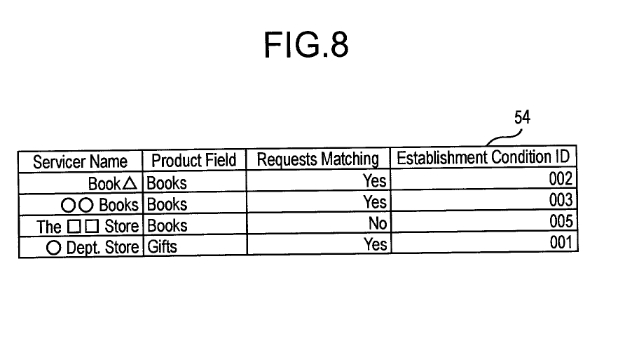

The matching result database 54 is a database storing the execution results of the matching program 41, which is provided for every user. FIG. 8 is a diagram showing the data structure of the matching result database 54. As shown in FIG. 8, the matching result database 54 is composed of records respectively consisting of the fields of: “servicer name”; “product field”; “requests matching”; and “establishment condition ID”. Such records are prepared for respective servicers. The “requests matching” field shows whether the sales conditions and establishment conditions proposed by the servicer match the user's desiring conditions, and takes the value “Yes” when the former match the letter and the value “No” when the former do not match the latter. The “establishment condition ID” field stores the establishment condition ID which is recorded in the second servicer's proposing condition database 53 for defining the condition under which this servicer was extracted for this user company.

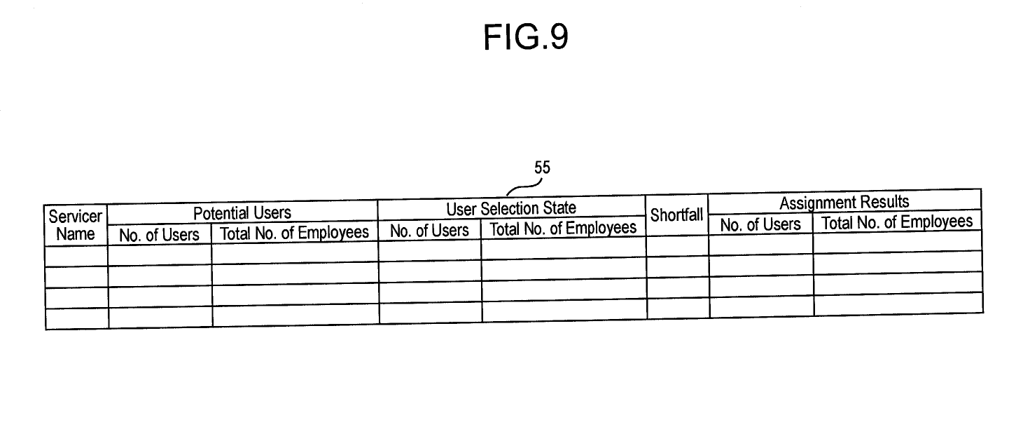

The servicer adjustment table 55 is a table that records, for each servicer, the total number of user companies and total number of employees belonging to all user companies that have selected that servicer. The servicer adjustment tables 55 is prepared for each product field. FIG. 9 is a diagram showing the data structure of this servicer adjustment table 55. As shown in FIG. 9, the servicer adjustment table 55 is composed of records respectively consisting of the fields of: “servicer name”; “potential users”; “user selection state”; “shortfall”; and “assignment results”. These records are prepared for respective servicers. The “potential users” field is sectioned into a “number of users” and a “total number of employees” subfields. The “number of users” subfield in the “potential users” field shows the total number of user companies about which the result of execution of the matching program 41 for this servicer is “Yes”. The “total number of employees” subfield in the “potential users” field shows the total number of employees in all of these user companies. The “user selection state” field is sectioned into a “number of users” and a “total number of employees” subfields. The “number of users” subfield in the “user selection state” field shows the total number of user companies that have selected the servicer to have establish a virtual outlet on the portal screen intended for their employees. The “total number of employees” subfield in the “user selection state” field shows the total number of employees in all of these user companies. The “shortfall” field shows, when a desired total number of employees is set for a servicer in the servicer first condition database 52, the result produced by subtracting the value in the “total number of employees” subfield in the “user selection state” field from this desired total number of employees. The “assignment results” field is also sectioned into a “number of users” and a “total number of employees” subfields. The “number of users” subfield in the “assignment results” field shows the total number of user companies that entrust the selection of a servicer to the establishment mediation server 30 and for whom the servicer has been selected. The “total number of employees” subfield in this “assignment results” field shows the total number of employees in all of these users.

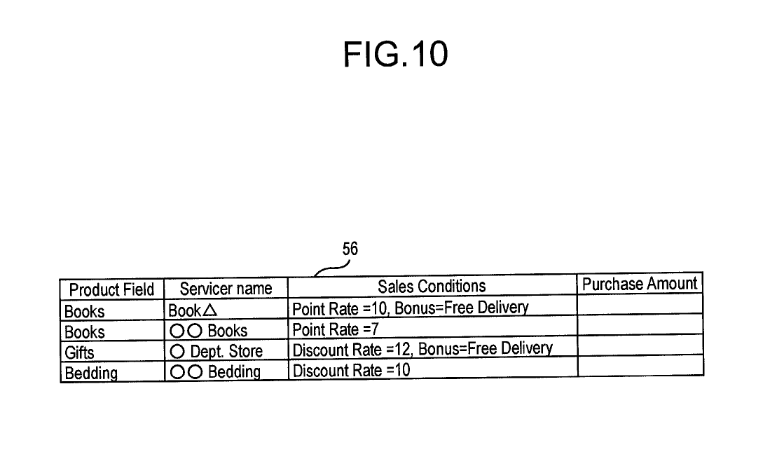

The established outlet database 56 is a database that stores data relating to servicers that have been selected through the execution of the assigning program 43 and servicers that have been selected by the user. The established outlet database 56 is prepared for each user. FIG. 10 is a diagram showing the data structure of the established outlet database 56. As shown in FIG. 10, the established outlet database 56 is composed of records respectively consisting of the fields of: “product field”; “servicer name”; “sales conditions”; and “purchase amount”. These records are prepared for respective servicers. The “servicer name” field shows the name of the servicer that has been ultimately selected by the user company to have establish a virtual outlet on the portal screen. The “sales conditions” field shows the conditions under which the employee of this user can purchase merchandise from this servicer, and which includes a “discount rate”, a “point rate” or a “bonus”. The “purchase amount” shows the total amount of purchase price of products that have been bought by the employee of this user company through the virtual outlet of this servicer, which is added with purchase price of merchandise every time an employee makes purchases.

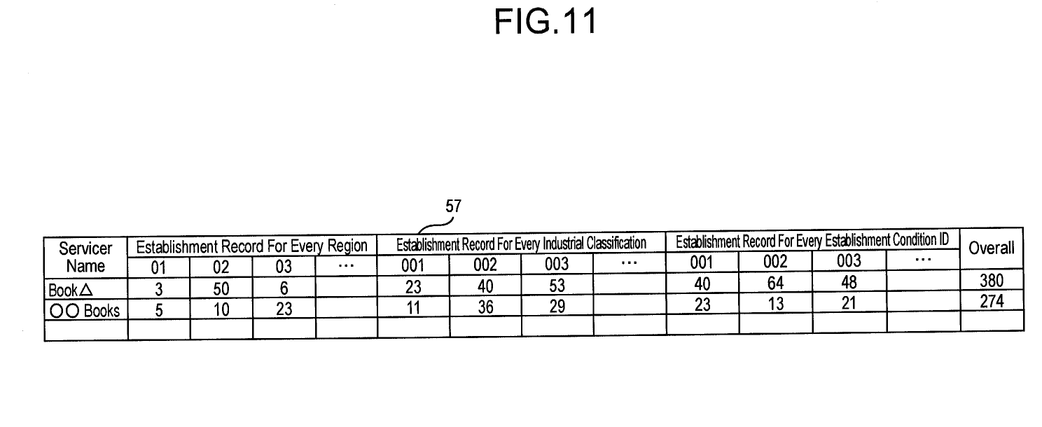

The establishment record database 57 is a database for storing data relating to the outlet establishment record of a servicer. FIG. 11 is a diagram showing the data structure of the establishment record database 57. As shown in FIG. 11, the establishment record database 57 is composed of records respectively consisting of the fields of: “servicer name”; “establishment record for every region”; “establishment record for every industrial classification”; “establishment record for every establishment condition ID”; and “overall”. These records are prepared for respective servicers. The “establishment record for every region” field is sectioned into subfields for respective region IDs. In each of these subfields, the total number of user companies with this region ID which select this servicer to have establish a virtual outlet on portal screens intended for their employees. The “establishment record for every industrial classification” field is also sectioned into subfields for respective industrial classification IDs. In each of these subfields, the total number of user companies with this sector ID which select this servicer to have establish a virtual outlet on portal screens intended for their employees. The “establishment record for every outlet condition ID” field is also sectioned into subfields for each outlet condition ID. In each of these subfields, the total number of user companies for which the servicer was extracted based on this outlet condition ID and which selects the servicer. The “overall” field shows the total number of users that have selected the servicer to have establish a virtual outlet on the portal screen intended for their employees.

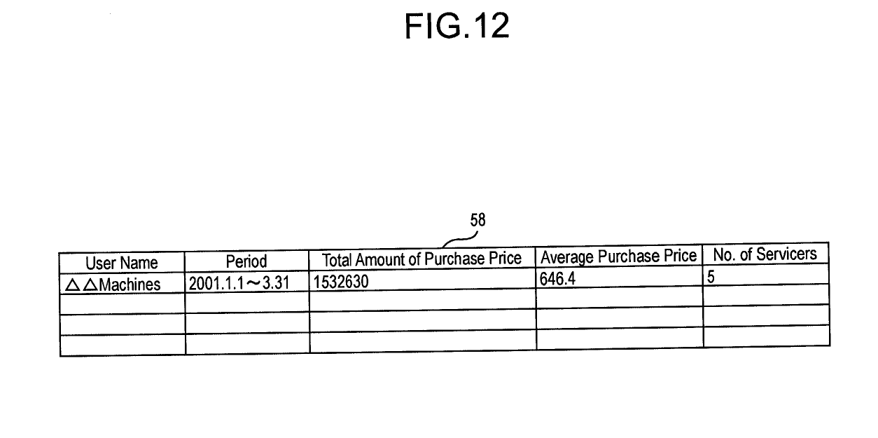

The purchase record database 58 is a database for storing data relating to the total amount of purchases made by employees belonging to the users. FIG. 12 is a diagram showing the data structure of the purchase record database 58. As shown in FIG. 12, the purchase record database 58 is composed of records respectively consisting of the fields of: “user name”; “period”; “total amount of purchase price”; “average purchase price”; and “number of servicers”. These records are prepared for respective user companies. The “total amount of purchase price” field shows the total amount of purchase prices of merchandise bought by the employee belonging to the user in a predetermined period. The “number of servicers” field shows the total number of servicers that have established virtual outlets on the portal screen intended for the employees belonging to the user company. The “average purchase price” field shows the average purchase price per servicer, and is found by dividing the value in the “total purchases” field by the value in the “number of servicers” field.

The following describes the detail of the processing executed by the computer network system described above.

The establishment mediation server 30 is always able to accept applications for the invitation of the establishment of virtual outlets from the persons in charge at each user company through a registration screen exclusive to the user company. When the user's desiring conditions have been inputted in the registration screen, the CPU 31 of the establishment mediation server 30 stores these conditions in the user's desiring condition database 51. Also, the establishment mediation server 30 is always able to accept applications for the establishment of virtual outlets from servicers via a web page that is available via the Internet. When sales conditions and establishment conditions for a virtual outlet proposed by a servicer have been inputted into this web page, the CPU 31 stores the sales conditions in the first servicer's proposing condition database 52 and the establishment conditions in the second servicer's proposing condition database 53.

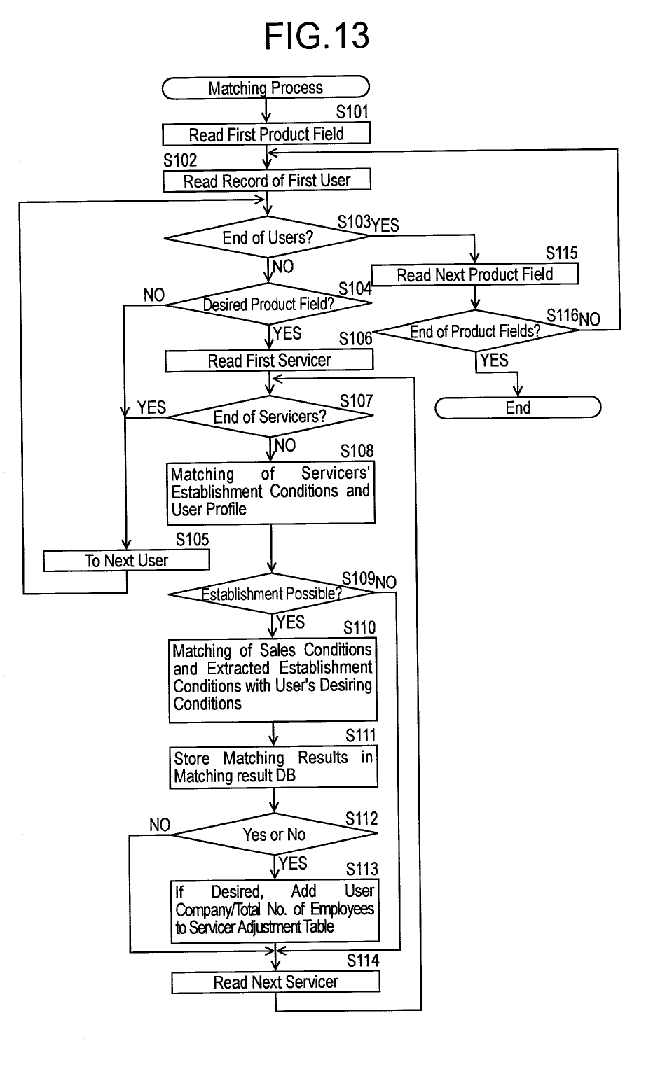

In the establishment mediation server 30, while accepting applications from the persons in charge at user companies who wish to have a virtual outlet established and applications for the establishment of virtual outlets from servicers, the matching process for extracting servicers for each user company is performed periodically. This matching process commences with the CPU 31 reading the matching program 41. FIG. 13 is a flowchart showing the matching process.

As shown in FIG. 13, in the first step S101 after starting the matching process, the CPU 31 reads the first product field from a product field list (not shown in the drawings).

Next, in S102, the CPU 31 executes a process for reading all of the records for the first user company from the user's desiring condition database 51.

Next, in S103, the CPU 31 checks whether a record has been read by the processing in S102 (or S105). When a record has been read, the CPU 31 advances the processing to S104.

In S104, the CPU 31 checks whether the record that has been read in S102 (or S105) includes the same product field as the product field read in S101 (or S115). In other words, the CPU 31 checks whether the user company wishes to have a virtual outlet established for this product field on the portal screen. When the user company does not wish to have a virtual outlet established for this product field on the portal screen, in S105, the CPU 31 executes a process for reading all of the records for the next user from the user's desiring condition database 51, and returns the processing to S103.

On the other hand, when it is judged in S104 that the user company wishes to have a virtual outlet established for the product field read in S101 (or S115) on the portal screen, the CPU 31 proceeds to S106.

In S106, the CPU 31 executes a process for reading, from the first servicer's proposing condition database 52, the record for the first servicer that includes the product field that was read in S101 (or S115).

Next, in S107, the CPU 31 checks whether a record has been read by the processing in S106 (or S114). When any records has not been read, the CPU 31 proceeds to S105 to execute the processing for reading all the records for the next user company from the user's desiring condition database 51, and thereafter returns to S103.

On the other hand, it is judged in S107 that a record has been read, in S108, the CPU 31 reads the second servicer's proposing condition database 53 corresponding to the servicer name included in this record read in S106 (or S114) and matches the attributes (user name, total number of employees, average income, industrial classification ID, business group ID, etc.) of the user company that were read from the user's desiring condition database 51 by the process in S102 (or S105) against the content of the “conditions” field in the read second servicer's proposing condition database 53 for this servicer. In more detail, the CPU 31 compares the attributes of the user company with the content of the “conditions” field in each of records in the second servicer's condition database 53, record by record, in order of “establishment condition ID contained therein, starting from the record having the lowest “establishment condition ID”. Then, finding out a record with the “conditions” matching the attributes of the present user, the CPU 31 reads the first finding out record including these “conditions” from the second servicer's proposing condition database 53.

Next, in S109 the CPU 31 checks whether the “establishment indication” field in the record read in S108 shows to “establish outlet” or to “exclusively establish outlet” or alternatively shows to “establish no outlet”. When the “establishment indication” field shows to “establish no outlet”, the CPU 31 proceeds directly to S114.

On the other hand, when the “establishment indication” field shows to “establish outlet” or to “exclusively establish outlet” (S109: YES), in S110, the CPU 31 matches the servicer's attributes, that is to say, the sales conditions (“product lineup”, “payment methods” “delivery time”) in the record read from the first servicer's proposing condition database 52 in S106 (or S114) and the establishment conditions (“discount rate”, and “point rate”) in the record read from the second servicer's proposing condition database 53 in S108, against the user's desiring conditions (“desired product lineup”, “desired payment methods”, “desired delivery time”, “desired discount rate”, and “desired point rate”) of the user that are included in the record for the product field in question among the records read from the user's desiring condition database 51 in S102 (or S105).

Next, in S111, the CPU 31 stores a new record, including the “servicer name”, the “product field”, and the “establishment condition ID” that is included in the record read from the second servicer's proposing condition database 53 in S108, into the matching result database 54, and writes the result of the matching (comparison) performed in S110 into the “requests matching” field in the same record, using the value “Yes” when the sales conditions and the establishment conditions satisfy all of the user's desiring conditions and the value “No” when there is at least one condition that is not satisfied.

Next, in S112, the CPU 31 checks whether the matching result written in the record stored in the matching result database 54 in S111 is “Yes” or “No”. When the matching result is “No”, the CPU 31 proceeds directly to S114.

On the other hand, when the matching result is “Yes”, in S113, the CPU 31 increments the value in the “number of users” subfield of the “potential users” field included in the record for the servicer in question on the servicer adjustment table 55 for the product field in question, and also adds the number of employees of the user company in question that was read by the processing in S102 (or S105) to the “total number of employees” subfield in the same “potential users” field. It should be noted that when there is no record for the servicer in question on the servicer adjustment table 55, the CPU 31 adds a new record (with zero in each field other than the “servicer name” field”) for the servicer to the servicer adjustment table 55 and performs the processing described above. Then, the CPU 31 proceeds to step S114.

In S114, the CPU 31 executes a process for reading a record for a next servicer that includes the product field read in S101 (or S115) from the first servicer's proposing condition database 52. After completing S114, the CPU 31 returns to S107.

When, as a result of repeatedly execution of the processing loop of S107 through S114 described above, the user's conditions desired by the user company in question have been compared with the sales conditions and establishment conditions made by all servicers, it is not possible to read any records for another servicer from the first servicer's proposing condition database 52, so that the CPU 31 proceeds from S107 to S105 where the CPU 31 executes the processing for reading all the records for the next user company from the user's desiring condition database 51 and thereafter returns to S103.

When, as a result of repeatedly execution of the processing loop of S103 through S114, completing the processing for all user companys, it is not possible to read any records for another user company from the user's desiring condition database 51, so that the CPU 31 proceeds from S103 to S115 where the CPU 31 executes the processing for reading a next product field from a product field list (not shown in the drawings).

Next, in S116, the CPU 31 checks whether a product field has been read by the processing in S115. When a product field has been read, the CPU 31 returns to S102. On the other hand, when no product field has been read by the processing in S115, the CPU 31 ends the entire matching process.

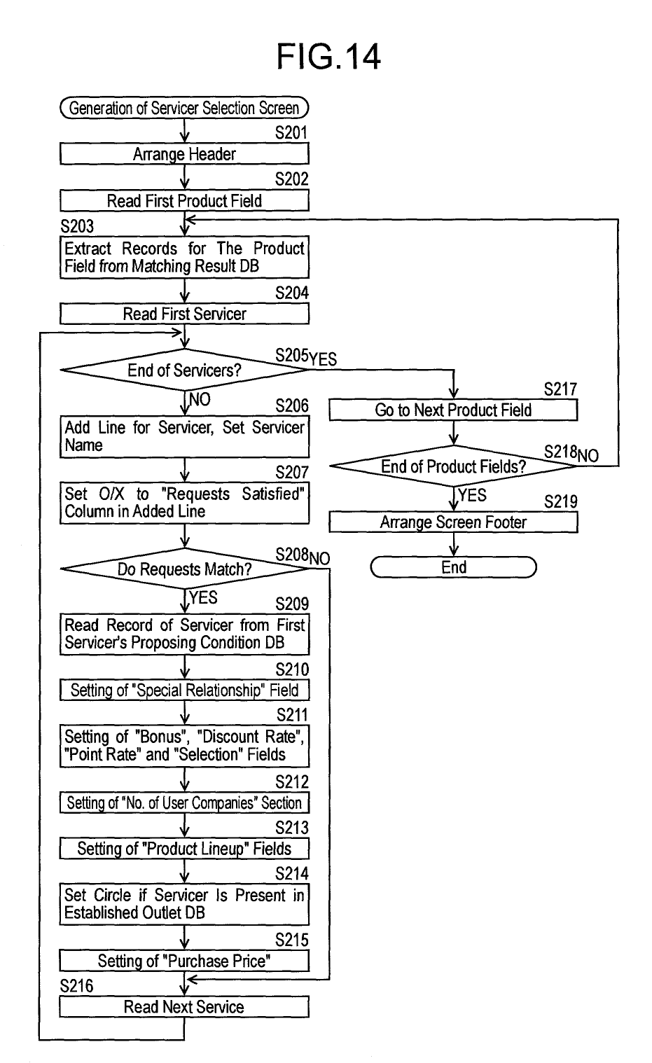

As a result of the matching process described above, matching result for each user company and each servicer is stored in the matching result database 54. Then, if the establishment mediation server 30 receives a request from a user terminal 10 that is operated by a person in charge at a user company, the establishment mediation server 30 executes a process for generating a servicer selection screen for informing the person in charge of the matching results and sends the servicer selection screen as a reply. It should be noted that FIG. 17 shows an example of the servicer selection screen 61. As shown in FIG. 17, rectangular data display frames 61a through 61c are indicated in the servicer selection screen 61 so as to display information relating to each servicer for every product field (books, gifts, bedding) in which the user company wishes to have a virtual outlet established on the portal screen intended for their employees. In more detail, the data display frames 61a through 61c are divided into columns with the headings “selection”, “shop name”, “requests satisfied”, “special relationship”, “bonus”, “discount rate or point rate”, “number of user companies”, “product lineup”, “present state”, and “purchase record”. Rows respectively consisting of information in those columns are provided for respective servicers. A checkbox is provided on each row in the “selection” column. A checkbox 61d is also shown next to each of the data display frames 61a through 61c to be checked by the person in charge at a user company to entrust the selection of a servicer to the establishment mediation server 30. The processing for generating such a servicer selection screen 61 commences with the CPU 31 reading a servicer selection screen generating program 42. It should be noted that the servicer selection screen generating process is performed separately for each user. The detail of the servicer selection screen generating process is shown in FIG. 14.

As shown in FIG. 14, in the first step S201 after starting the servicer selection screen generating process, the CPU 31 arranges a header at the top of the blank dialog. The header includes the fixed text “Please select a shop to be established on the portal screen intended for employees of your company”, and the user name added with the form of “XXX Ltd., Dear Sir/Madam” thereafter.

Next, in S202, the CPU 31 reads the first product field from a product field list (not shown in the drawings).

Then, in S203, the CPU 31 extracts all of the records for the user company in question that include the product field read by the processing in S202 (or S217) from the matching result database 54.

Next, in S204, the CPU 31 executes a process for reading the records including the first servicer name, out of all the records extracted in S203.

Next, in S205, the CPU 31 checks whether a record has been read by the processing in S204 (or in S216). When a record has been read, the CPU 31 proceeds to S206.

In S206, the CPU 31 adds a row including the “servicer name” (hereafter referred to the “servicer name in question”) in the record read by the processing in S204 (or S216), to the data display frame 61a through 61c for the product field in question in the dialog. It should be noted that if there is no data display frame 61a through 61c for the product field in question in the dialog, the CPU 31 arranges a new data display frame 61a through 61c for this product field and then adds thereto a row for the servicer name in question.

Next, in S207, if the value in the “requests matching” field in the record read by the processing in S204 (or S216) is “Yes”, the CPU 31 draws a circle in the “requests satisfied” column in the row added in S206. If the value in the “requests matching” field is “No”, the CPU 31 draws a cross in the “requests satisfied” column.

Next, in S208, the CPU 31 checks whether the value in the “requests matching” field in the record read by the processing in S204 (or S216) is “Yes” or “No”. When the value is “No”, the CPU 31 proceeds to S216.

On the other hand, when the value in the “requests matching” column is “Yes”, in S209, the CPU 31 reads the record including the servicer name in question from the first servicer's proposing condition database 52.

Next, in S210, the CPU 31 reads the record including the user name of the user company in question from the user's desiring condition database 51. Then, the CPU 31 checks whether the “business group ID” in the record read from the user's desiring condition database 51 is the same as the “business group ID” in the record read from the first servicer's proposing condition database 52. When both “business group IDs” are the same as each other, the CPU 31 writes a word “group” in the “special relationship” column in the row that was added to the data display frame in S206. On the other hand, when the “business group IDs” are different from each other, the CPU 31 writes a symbol “-” in this column. It should be noted that information showing other kinds of business relationships may be set in this “special relationship” column. After completing S210, the CPU 31 proceeds to S211.

In S211, the CPU 31 reads, from the second servicer's proposing condition database 53 corresponding to the servicer name in question, the values in the “bonus”, “discount rate”, and “point rate” fields corresponding to the “establishment condition ID” included in the record read by the processing in S204 (or S216). Then, the CPU 31 writes the values read from the “bonus”, “discount rate”, and “point rate” fields into the “bonus” column and “discount rate” or “point rate” column in the row that was added to the data display frame in S206. Further, the CPU 31 reads, from second the servicer's proposing condition database 53 corresponding to the servicer name in question, the content of the “establishment indication” field corresponding to the “establishment condition ID” included in the record read by the processing in S204 (or S216). Then, if the content of the “establishment indication” shows to exclusively establish outlet”, the CPU 31 places an asterisk (*) next to the checkbox in the “selection” row that was added to the data display frame in S206. At the same time, if the “request indication” included in the record read from the first servicer's proposing condition database 52 in S209 is “1” or “2” and data is present in the “charge discount rate” in the record, the CPU 31 adds an exclamation mark (!) next to the checkbox in the “selection” row that was added to the data display frame in S206.

Next, in S212, the CPU 31 reads the record including the servicer name in question from the establishment record database 57. Then, the CPU 31 extracts, from the record read from the establishment record database 57, the number of outlets corresponding to the “establishment condition ID” field mentioned above, the number of outlets corresponding to the “region ID” included in the record read from the user's desiring condition database 51 in S210, the number of outlets corresponding to the “industrial classification ID” field, and the number of outlets written in the “overall” field. Then, the CPU 31 writes the extracted numbers of outlets into the “same condition” subcolumn in the “number of user companies” column, the “same region” subcolumn in the “number of user companies” column, the “same industrial classification” subcolumn in the “number of user companies” column, and the “overall” subcolumn in the “number of user companies” column, respectively.

Next, in S213, the CPU 31 sets the value in the “product lineup” field included in the record read from the first servicer's proposing condition database 52 in S209 in the “product lineup” column in the row added to the data display frame in S206.

Next, in S214, the CPU 31 checks whether a record including the servicer name in question is present in the established outlet database 56 for the user company in question. When such a record is present, the CPU 31 draws a circle in the “present state” column in the row that was added to the data display frame in S206. On the other hand, when there is no such record, the CPU 31 writes a cross in the “present state” column.

Next, in S215, the CPU 31 reads, from the established outlet database 56 for the user company in question, the value in the “purchase amount” field from the record including the servicer name in question. Then, the CPU 31 sets the value in the “purchase record” column in the row that was added to the data display frame in S206. After completing S215, the CPU 31 proceeds to S216.

In S216, the CPU 31 executes a process for reading, out of the records extracted in S203, a record including the next servicer name. After completing S216, the CPU 31 returns to S205.

When, as a result of repeatedly execution of the processing loop of S205 through S216, the processing is completed for all servicer names included in the records extracted in S203, it is no longer possible to read any records including next servicer names from the records extracted in S203, so that the CPU 31 proceeds from S205 to S217 and executes a process for reading a next product field from the product field list (not shown in the drawings).

Next, in S218, the CPU 31 checks whether a product field has been read by the processing in S217. When a product field has been read, the CPU 31 returns to S203.

On the other hand, when a product field has not been read, the CPU 31 arranges a footer at the bottom of the dialog to complete the servicer selection screen. The footer includes the fixed text “N.B. Selecting a shop marked with an asterisk makes it impossible to select another shop in the same product field. Selecting a shop marked with an exclamation mark results in a discount in the fees to be charged your company.” After completing S219, the CPU 31 ends the servicer selection screen generating process.

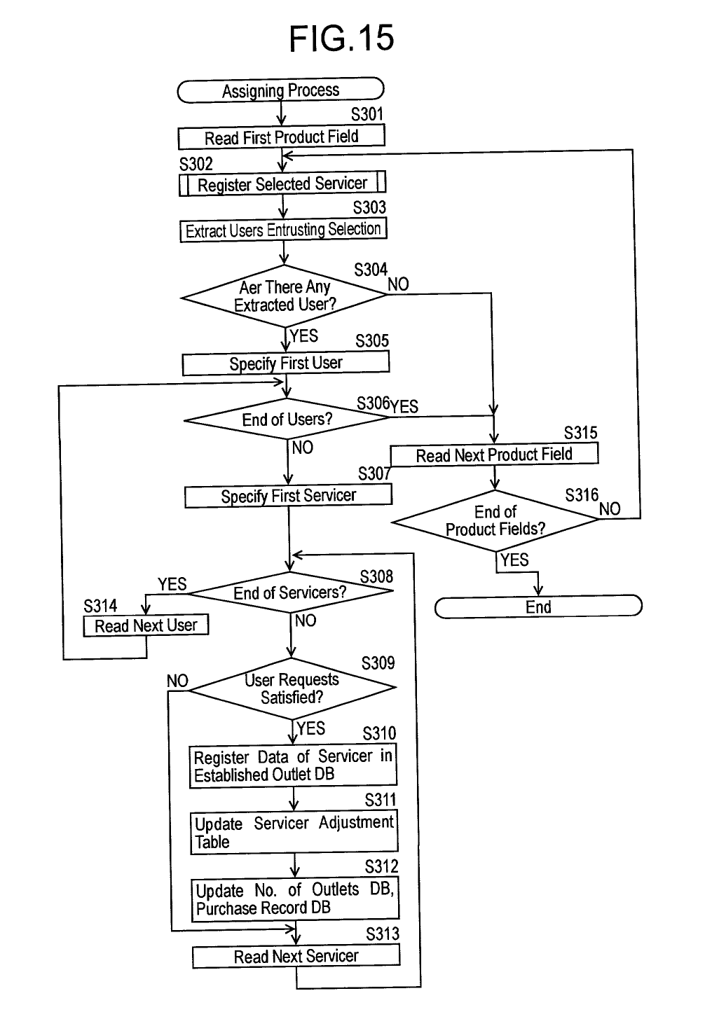

In the servicer selection screen generating process shown above, a servicer selection screen 61 for the user is generated in accordance with a request received from a user terminal 10 that is operated by a person in charge at the user company. Then, the generated servicer selection screen 61 is transmitted from the establishment intermediary server 30 to the user terminal 10 that issued the request. The servicer selection screen 61 is received and displayed on the display 10a of the user terminal 10, and when the person in charge checks one or more of the checkboxes and then clicks on a “submit” button 61e, a message showing the content of the servicer selection screen that has been checked is transmitted to the establishment mediation server 30. The establishment mediation server 30 records the content of the received message temporarily in the HDD 36. Then, the establishment mediation server 30 periodically executes an assigning process based on the content of the messages that have been temporarily stored. This assigning process is executed by the CPU 31 reading the assigning program 43. The detail of this assigning process is shown in FIG. 15.

As shown in FIG. 15, in the first step S301 after starting the assigning process, the CPU 31 reads the first product field from the product field list (not shown in the drawings).

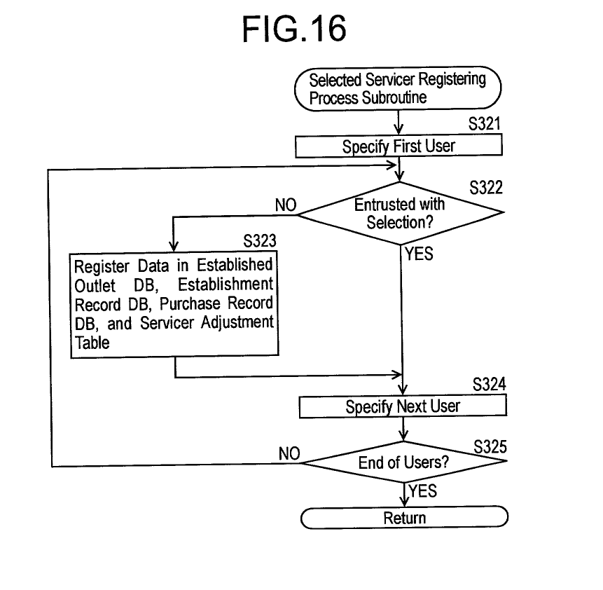

Next, in S302, the CPU 31 executes a selected servicer registering process subroutine. The detail of this selected servicer registering process subroutine is shown in FIG. 16.

As shown in FIG. 16, in the first step S321 after entering the selected servicer registering process subroutine, the CPU 31 specifies the first user company to be processed.

Next, in S322, the CPU 31 investigates, based on the content of the messages received from the user company in question that have been temporarily stored in the HDD 36, whether the person in charge at the user company in question has checked the checkbox 61d corresponding to the product field in question in the servicer selection screen 61. If the person in charge at the user company in question has checked the checkbox 61d corresponding to the product field in question, the CPU 31 proceeds directly to S324. On the other hand, if the person in charge at the user company in question has not checked the checkbox 61d corresponding to the product field in question, the CPU 31 proceeds to S323.

In S323, the CPU 31 investigates servicer (i.e., shop name) of which checkbox in the data display frames 61a through 61c corresponding to the product field in question on the servicer selection screen 61 is checked by the person in charge at the user company in question. Next, the CPU 31 inputs information of the servicer selected with the check by the person in charge at the user company into the established outlet database 56 for the user company in question, the establishment record database 57, the purchase record database 58, and the servicer adjustment table 55. In more detail, the CPU 31 adds a record including (i) the product field in question, (ii) the selected servicer name, (iii) the sales conditions (“bonus” and “point rate” or “discount rate”) corresponding to the servicer name in the data display frames 61a through 61c, and (iv) a purchase amount set at zero, to the established outlet database 56 for the user company in question. The CPU 31 adds one to the respective subfields corresponding to the region ID and the industrial classification ID of the user company in question in the “establishment record for every region” and “establishment record for every industrial classification” fields in the record corresponding to the selected servicer in the establishment record database 57. At the same time, also in the same record corresponding to the selected servicer in the establishment record database 57, the CPU 31 adds one to the subfield in the “establishment record for every establishment condition ID” field that corresponds to the establishment condition ID for the selected servicer stored in the matching result database 54 for the user company in question. It should be noted that when there is no record for the selected servicer in the establishment record database 57, the CPU 31 adds a new record for the selected servicer to the establishment record database 57 and then performs the above processing. Further, the CPU 31 increments the value in the “number of servicers” field included in the record for the user company in question in the purchase record database 58 by one, and recalculates the value in the “average purchase price” field. It should be noted that when there is no record for the user company in question in the purchase record database 58, the CPU 31 newly adds a record for the user company in question, sets the “total amount of purchase price” and “average purchase price” fields at zero, sets the “number of servicers” at one, and set the present date in the “period” field. The CPU 31 also increments the value in the “number of users” subfield in the “user selection state” field included in the record corresponding to the selected servicer in the servicer adjustment table 55 by one. In addition, the CPU 31 reads the number of employees belonging to the user company in question from the user's desiring condition database 51 and adds the number to the “total number of employees” subfield in the “user selection state” field in the record corresponding to the selected servicer in the servicer adjustment table 55. After completing S323, the CPU 31 proceeds to S324.

In S324, the CPU 31 executes a process for specifying the next user company to be processed.

Next, in S325, the CPU 31 checks whether a user company has been specified by the processing in S324. When a user company has been specified as to be processed, the CPU 31 returns to S322. On the other hand, when no user company can be specified to be processed, the CPU 31 ends the selected servicer registering process subroutine, and returns to the processing of the main routine shown in FIG. 15.

In the main routine, the processing proceeds from S302 to S303 where the CPU 31 executes a process for extracting, based on all messages that have been received from a user company and temporarily stored in the HDD 36, all user companies whose persons in charge have checked a checkbox 61d corresponding to a product field in question on the servicer selection screen.

Next, in S304, the CPU 31 checks whether a user company has been extracted by the processing in S303. When no user company have been extracted, the CPU 31 proceeds to S315. On the other hand, when at least one user company has been extracted, in S305, the CPU 31 executes a process for specifying a first user company to be specified (the user in question), out of the user companies extracted by the processing in S303.

Next, in S306, the CPU 31 checks whether a user company has been specified to be processed by the processing in S305 (or S314). When a user company has been specified to be processed, in S307, the CPU 31 executes a process for reading a record that includes the first servicer name from the matching result database 54 for the user company in question.

Next, in S308, the CPU 31 checks whether a record has been read by the processing in S307 (or S313). When a record has been read, in S309, the CPU 31 checks whether the value in the “requests matching” field in this read record is “Yes” or “No”. When the value in the “requests matching” field is “No”, the CPU 31 proceeds directly to S313. On the other hand, when the value in the “requests matching” field is “Yes”, in S310, the CPU 31 adds, to the established outlet database 56 for the user company in question, a record including the product field in question, the value in the “servicer name” field in the record read from the matching result database 54 by the processing in S307 (S313), the sales conditions (bonus, and point rate or discount rate) corresponding to this servicer name in the data display frames 61a through 61c corresponding to the product field in question, and a “purchase amount” which is set at zero.

Next, in S311, the CPU 31 reads, from the servicer adjustment table 55, a record that includes the “servicer name” included in the record read from the matching result database 54 by the processing in S307 (S313). Then, the CPU 31 reduces the value in the “shortfall” field in the record read from the servicer adjustment table 55 by the number of employees belonging to the user company in question that has been read from the user's desiring condition database 51. At the same time, the CPU 31 increments the value in the “number of users” subfield in the “assignment results” field included in the record read from the servicer adjustment table 55 by one, and adds the number of employees belonging to the user in question to the value in the “number of employees” subfield in the “assignment results” field.

Next, in S312 the CPU 31 reads a record, including the “servicer name” included in the record read from the matching result database 54 by the processing in S307 (S313), from the establishment record database 57. Then, the CPU 31 adds one to the respective subfields corresponding to the region ID and the industrial classification ID of the user company in question in the “establishment record for every region” and “establishment record for every industrial classification” fields in the record read from the establishment record database 57. At the same time, also in the same record read from the establishment record database 57, the CPU 31 adds one to the subfield in the “establishment record for every establishment condition ID” that corresponds to the establishment condition ID for the servicer in question stored in the matching result database 54 for the user company in question. It should be noted that when there is no record including the servicer name of the servicer in question in the establishment record database 57, the CPU 31 adds a new record including the servicer name to the establishment record database 57 and then performs the above processing. Further, the CPU 31 increments the value in the “number of servicers” field included in the record for the user company in question in the purchase record database 58 by one. It should be noted that when there is no record for the user company in question in the purchase record database 58, the CPU 31 newly adds a record for the user company in question to the purchase record database 58, sets the “total amount of purchase price” and “average purchase price” fields at zero, sets the “number of servicers” at one, and sets the present date in the “period” field. After completing this processing, the CPU 31 proceeds to S313.

In S313, the CPU 31 executes a process for reading a record including the next servicer name from the matching result database 54 for the user company in question. After completing S313, the CPU 31 returns to S308.

When, as a result of repeatedly execution of the processing loop of S308 through S313, completing the assigning process for the user company in question, it is no longer possible to read a record including a next servicer name from the matching result database 54, so that the CPU 31 proceeds from S308 to S314 where it executes the processing for specifying the next user company in question from the users that were extracted by the processing in S303, and thereafter returns to S306.

When, as result of repeatedly execution of the processing loop of S306 through S314, completing the assigning process for every user company, it is no longer possible to specify the next user company in question, so that the CPU 31 proceeds from S306 to S315.

In S315, the CPU 31 executes a process for reading the next product field from the product field list (not shown in the drawings).

Next, in S316, the CPU 31 checks whether a product field has been read by the processing in S315. When a product field has been read, the CPU 31 returns to S302. On the other hand, when no product field has been read, the CPU 31 ends the assigning process.

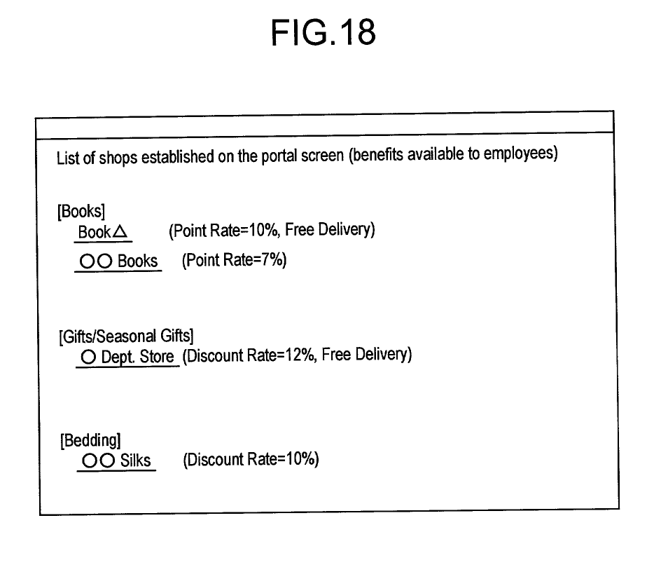

By performing the above assigning process, a servicer that has been automatically selected by the establishment mediation server 30 in response to the checkbox 61d corresponding to a product field in question in the servicer selection screen 61 being checked by the person in charge at a user company, or a servicer that has been selected by the person in charge at the user company is ultimately registered as the party with whom the user company enters a contract. As a result, a virtual outlet of the servicer that is registered in this way is established on the portal screen intended for employees of the user and the person in charge at the user is informed of the result of this registration. This information is performed by transmitting a servicer list screen 62, as shown in FIG. 18 for example, to the user terminal 10. In the servicer list screen 62 shown in FIG. 18, the servicer name of the servicer that has been selected by the user company or by the establishment mediation server 30 is shown along with the conditions offered to the user by this servicer.

When an employee belonging to a user purchases a product through a virtual outlet to which the portal screen is linked, information of actual purchase price for the product is sent to both the servicer terminal 20 and the establishment mediation server 30. Then, receiving the information of actual purchase price, the establishment mediation server 30 adds the actual purchase price to the total amount in the established outlet database 56 and the purchase record database 58. In more detail, when an employee belonging to a user company purchases a product, the actual purchase price is added to the “purchase amount” for the servicer who sold the product in the established outlet database 56 for the user company and also to the “total amount of purchase price” for the user company in the purchase record database 58, with the “average purchase price” also being recalculated.

As described above, in the present embodiment, the establishment mediation server 30 executing the matching process shown in FIG. 13 extracts, for each user company, servicers of which proposing conditions (average income, industrial classification, user name, etc.) match the user company's attributes (user name, total number of employees, average income, industrial classification ID, business ID, region ID, etc.). Further, out of the servicers that have been extracted in this way, servicers that proposes the sales conditions (product lineup, payment methods, delivery time) and establishment conditions (discount rate, point rate) matching the user's desiring conditions (product lineup, payment methods, delivery time, discount rate, point rate) are extracted. Also, with the present embodiment, if the user checks a checkbox 61d included in the servicer selection screen 61, the user can have a servicer automatically selected through the assigning process.

As described above, with the present embodiment, a service provider can mediate between a user that wishes to have a virtual outlet established on an web page exclusive for the members and a servicer who wishes to establish an outlet, making it possible for users and servicers to narrow down the selection of candidates of counter part of the contract.

We claim:

1. A virtual outlet establishment mediation method for mediating between a user who wishes to have a virtual outlet established on an web page that is transmitted via a network to a terminal operated by a member of the user and a servicer who wishes to establish a virtual outlet, said method comprising steps of:
extracting combinations of a user and a servicer in which attribute of each of them satisfies other's desiring condition by comparing attribute of each user with condition that is desired by each servicer with regard to attributes of users and by comparing attribute of each servicer with condition that is desired by each user with regard to attributes of servicers;
presenting, to a requesting user, a screen showing attributes of servicers combined with the requesting user in the combinations extracted in the extracting step and the conditions that are desired by the servicers, and
registering a servicer selected by the requesting user to whom the screen has been presented in the presenting step as a servicer who is to establish a virtual outlet on an web page transmitted to members of the requesting user.

2. The virtual outlet establishment mediation method according to claim 1, wherein
the attributes of servicer include a record of actual establishment of virtual outlet by the servicer.

3. The virtual outlet establishment mediation method according to claim 1, wherein
the attributes of user include a record of actual purchases made by members of the user via virtual outlets.

4. A program for mediating between a user who wishes to have a virtual outlet established on an web page that is transmitted via a network to a terminal operated by a member of the user and a servicer who wishes to establish a virtual outlet, the program making a computer execute steps of:
comparing attribute of each user with condition that is desired by each servicer with regard to attributes of users;
comparing attributes of each servicer with condition that is desired by each user with regard to attributes of servicers;
extracting combinations of a user and a servicer in which attribute of each of them satisfies other's desiring condition;
presenting, to a requesting user, a screen showing attributes of servicers that combined with the requesting user in the combination extracted in the extracting step and the conditions that are desired by the servicers; and
registering a servicer selected by the requesting user to whom the screen has been presented as a servicer who is to establish a virtual outlet on an web page transmitted to members of the requesting user.

5. A computer-readable medium readable by a computer and storing a program for mediating between a user who wishes to have a virtual outlet established on an web page that is transmitted via a network to a terminal operated by a member of the user and a servicer who wishes to establish a virtual outlet, the program making the computer execute steps of:
comparing an attribute of each user with condition that is desired by each servicer with regard to attributes of users;
comparing an attribute of each servicer with condition that is desired by each user with regard to attributes of servicers;
extracting combinations of a user and a servicer in which attribute of each of them satisfies other's desiring condition;
presenting, to a requesting user, a screen showing attributes of servicers that combined with the requesting user in the combination extracted in the extracting step and the conditions that are desired by the servicers; and
registering a servicer selected by the requesting user to whom the screen has been presented as a servicer who is to establish a virtual outlet on an web page transmitted to members of the requesting user.

6. A virtual outlet establishment mediation server for mediating between a user who wishes to have a virtual outlet established on an web page that is transmitted via a network to a terminal operated by a member of the user and a servicer who wishes to establish a virtual outlet, comprising:
a storage unit for storing user's attribute information which defines attributes of users, user's request information which defines conditions that are respectively desired by the users with regard to attributes of servicers, servicer's attribute information which defines the attributes of the servicers, and servicer's request information which defines conditions that are respectively desired by the servicers with regard to the attributes of the users;
a matching unit for extracting combinations of a user and a servicer, in which a condition desired by the server that is defined in the servicer's request information matches an attribute of the user that is defined in the user's attribute information and in which a condition desired by the user that is defined in the user's request information matches an attribute of the server that is defined in the servicer's attribute information;
a screen presenting unit for presenting, to a requesting user, a screen showing attributes of servicers combined with the requesting user in the combinations extracted by the matching unit and the conditions that are desired by the servicers defined in the servicer's request information; and
a registering unit for registering a servicer selected by the requesting user to whom the screen has been presented by the screen presenting unit as a servicer who is to establish a virtual outlet on an web page transmitted to members of the requesting user.

7. The virtual outlet establishment mediation server according to claim 6, wherein
said registering unit selects, when the requesting user has inputted a predetermined instruction in the screen that is presented by the screen presenting unit, a servicer out of a plurality of servicers combined with the requesting user in the combinations extracted by the matching unit, and registers the selected servicer as the servicer who is to establish a virtual outlet on an web page transmitted to members of the requesting user.

8. The virtual outlet establishment mediation server according to claim 6, wherein
said storage unit stores, when a member of a user has purchased a product via a virtual outlet of a servicer, a record of actual purchase for the product as the user's attribute information.

9. The virtual outlet establishment mediation server according to claim 6, wherein
said storage unit stores, when the selected servicer has established a virtual outlet on an web page transmitted to members of a user, a record of actual establishment of the virtual outlet as the server's attributes information.

10. The virtual outlet establishment mediation server according to claim 6, wherein
the attribute of a user include an average income of employees of the user.

11. The virtual outlet establishment mediation server according to claim 6, wherein
the attribute of a servicer include a delivery time of the servicer.

12. The virtual outlet establishment mediation server according to claim 6, wherein
the attribute of a user include an industrial classification of the user.

13. The virtual outlet establishment mediation server according to claim 6, wherein
the attributes of a servicer include a discount rate offered by the servicer.
